(19) United States
(12) Patent Application Publication
(10) Pub. No.: US 2016/0261635 A1
(43) Pub. Date: Sep. 8, 2016

(54) TRIGGER EVENTS AND CONFIRMATION IN DIGITAL ASSET MANAGEMENT

(71) Applicant: Microsoft Technology Licensing, LLC, Redmond, WA (US)

(72) Inventors: Rajmohan Rajagopalan, Sammamish, WA (US); Michael Stokes, Redmond, WA (US)

(21) Appl. No.: 14/723,104

(22) Filed: May 27, 2015

Related U.S. Application Data
(60) Provisional application No. 62/128,883, filed on Mar. 5, 2015.

(51) Int. Cl. H04L 29/06

(52) U.S. Cl. CPC H04L 63/20; H04L 63/10

(57) ABSTRACT

Trigger events and confirmation in digital asset management are provided. A service such as a management service monitors digital assets of an asset owner and content associated with the asset owner hosted at external resources. A trigger event is detected within the content or the digital assets. The trigger event identifies information about an incapacitation of the asset owner. A notification is transmitted to an asset manager to prompt the asset manager to validate an incapacitation of the asset owner associated with the trigger event. In response to a confirmation of the incapacitation, actions are executed to dispose of the digital assets.

### CROSS-REFERENCE TO RELATED APPLICATION

This Application claims priority under 35 U.S.C. §119(e) to U.S. Provisional Patent Application Ser. No. 62/128,883 filed on Mar. 5, 2015. The disclosure of the U.S. Provisional Patent Application is hereby incorporated by reference in its entirety.

### BACKGROUND

The proliferation of computerized automation of processes in every aspect of life, data storage and processing have become a major component of networked systems handling social interactions. In such systems, social data is entered, modified, or deleted from a number of sources. Various social data stores from simple tables to complicated databases are maintained and synchronized as new entries or modifications are made by different sources. In addition, variety of services are offered to enable internal and external parties' interactivity with the social data hosted by the data stores. Incapacitation events associated with an owner of the social data present significant challenges in management and disposition of the social data.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to trigger events and confirmation in digital asset management. In some example embodiments, a management service may monitor digital assets of an asset owner and content associated with the asset owner hosted at external resources. The management service may detect a trigger event in the content. A notification may be transmitted to the asset manager to prompt the asset manager to validate the incapacitation of the asset owner associated with the trigger event. In response to the confirmation of the incapacitation of the asset owner from the asset manager, actions to dispose of the digital assets may be executed.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of providing trigger events and confirmation in digital asset management, according to embodiments;

FIG. 2 illustrates an example of interactions between a management service and external resources to provide trigger events and confirmation in digital asset management, according to embodiments;

FIG. 3 illustrates a component diagram of a management service that provide trigger events and confirmation in digital asset management, according to embodiments;

FIG. 4 illustrates an example of a user interface to provide trigger events and confirmation in digital asset management, according to embodiments;

FIG. 5 is a simplified networked environment, where a system according to embodiments may be implemented;

FIG. 6 illustrates a general purpose computing device, which may be configured to provide trigger events and confirmation in digital asset management, according to embodiments; and

FIG. 7 illustrates a logic flow diagram for a process to provide trigger events and confirmation in digital asset management, according to embodiments.

### DETAILED DESCRIPTION

As briefly described above, trigger events and confirmation in digital asset management may be provided by a management service. Digital assets of an asset owner and content associated with the asset owner hosted at external resources may be monitored by the management service. A trigger event may be detected within the content or the digital assets. A notification may be transmitted to an asset manager to prompt the asset manager to validate an incapacitation of the asset owner associated with the trigger event. In response to a confirmation of the incapacitation, the actions may be executed to dispose of the digital assets.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide trigger events and confirmation in digital asset management. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

A computing device, as used herein, refers to a device comprising at least a memory and one or more processors that includes a server, a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. Actions or operations described herein may be executed on a single processor, on multiple processors (in a single machine or distributed over multiple machines), or on one or more cores of a multi-core processor. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience—a visual display associated with an application or service through which a user interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

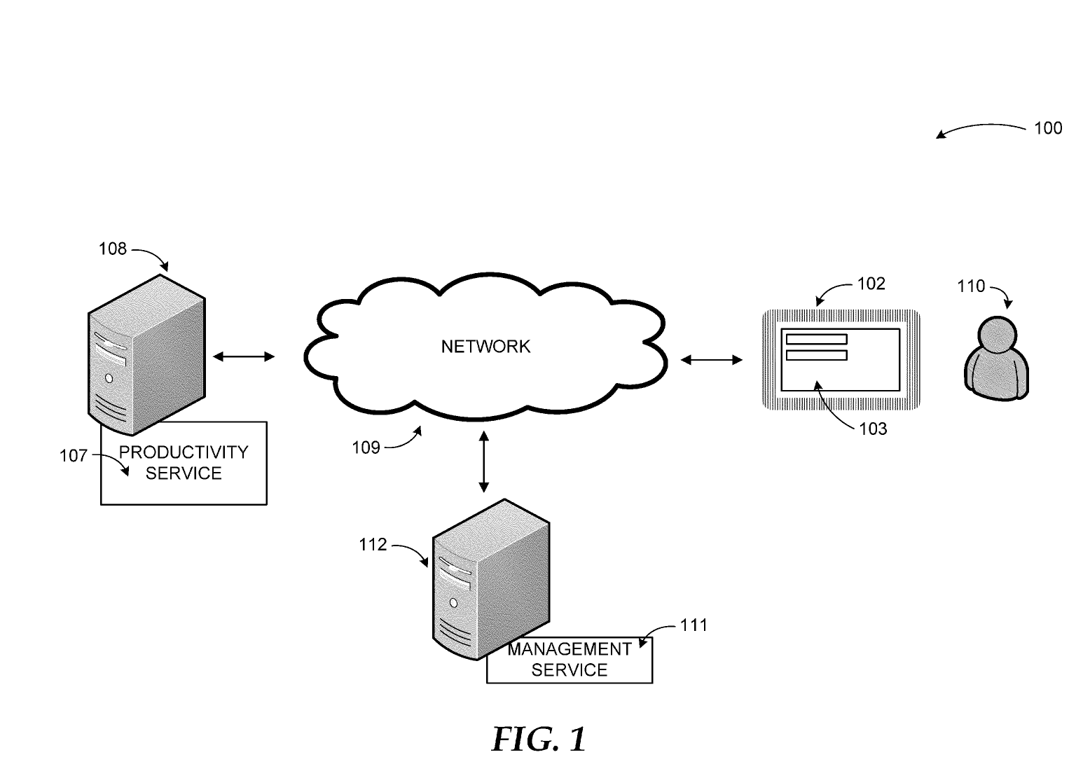

FIG. 1 is a conceptual diagram illustrating an example of providing trigger events and confirmation in digital asset management, according to embodiments.

In a diagram 100, a computing device 112 may execute a management service 111. An example of the management service 111 may include an application that provides information and data processing functionality. The computing device 112 may include a hardware based server, a laptop computer, and a desktop computer, among others.

The computing device 112 may communicate with an external resource 108 and a client device 102 through a network 109. The external resource 108 may provide a productivity service 107. Examples of the productivity service 107 may include a communication service, a social networking service, a professional networking service, an application service, and a storage service, among others. The communication service may facilitate communication between callers. The storage service may host digital assets associated with asset owners. The application service may provide applications for use and consumption by client devices.

The network 109 may include wired and wireless components that allow wired and wireless communication between nodes such as the external resource 108, the computing device 112, and the client device 102, among others. The client device 102 may display a client user interface (UI) 103 of the management service 111 to an asset manager 110. The client UI 103 may provide functionality to manage digital assets by allowing an asset manager 110 to customize trigger events, and actions to dispose of the digital assets, among others.

The management service 111 may monitor digital assets and content associated with an asset owner hosted at external resources. A trigger event that identifies an incapacitation of the asset owner may be detected within the content or the digital assets. A notification may be transmitted to the asset manager 110 through the client UI 103 of the management service 111 (displayed on the client device 102) to prompt the asset manager to validate the incapacitation. Actions to dispose of the digital assets may be executed in response to a confirmation of the incapacitation. Controls may be presented at the client UI 103 to allow the asset manager 110 to customize trigger events, actions, and selections of the digital assets to dispose in response to a trigger event.

The asset manager 110 may be allowed to interact with the client UI 103 through an input device or touch enabled display component of the client device 102. The client device 102 may include a display device such as the touch enabled display component, and a monitor, among others. The display device may be used to provide the client UI 103 of the management service 111 to the asset manager 110.

The asset manager 110 may interact with the client UI 103 with a keyboard based input, a mouse based input, a voice based input, a pen based input, and a gesture based input, among others. The gesture based input may include one or more touch based actions such as a touch action, a swipe action, and a combination of each, among others.

Digital assets such as pictures, documents, accounts, account information (such as account status information), among others hosted by the productivity service may be monitored. A workflow of actions, event triggers, selected the digital assets may be created to dispose of the digital assets in case of a trigger event. The asset manager 110 may be presented with controls to customize the workflow.

While the example system in FIG. 1 has been described with specific components including the computing device 112, the managing service 111, embodiments are not limited to these components or system configurations and can be implemented with other system configuration employing fewer or additional components.

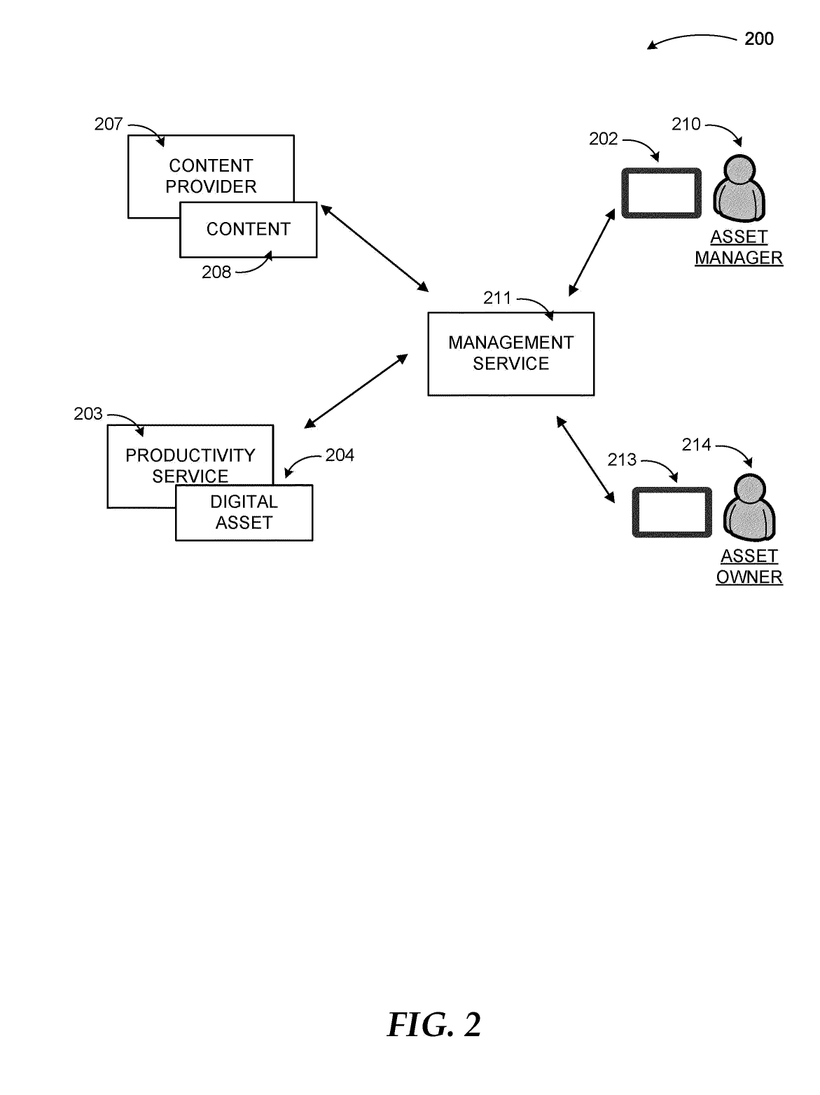

FIG. 2 illustrates an example of interactions between a management service and external resources to provide trigger events and confirmation in digital asset management, according to embodiments.

In a diagram 200, a management service 211 may interact with external resources and an asset manager 210, among others to provide trigger events and confirmation in digital asset management. The digital asset may include a document, an account, among others associated with an asset owner 214. Actions to dispose of the digital asset 204 may include operations such as an action to forward the digital asset 204 to a legal representative of the asset owner 214, an action to transmit credentials to the productivity service 203 associated with the digital asset 204 to the legal representative, an action to delete the digital asset 204, and an action to delete an accounts associated with the digital asset 204, among others.

A trigger event may include an information associated with an incapacitation of an asset owner 214. The incapacitation may include a death of the asset owner 214, a disablement of the asset owner 214, a hospitalization of the asset owner 214, an expatriation of the asset owner 214, a permanent relocation of the asset owner 214, an imprisonment of the asset owner 214, or a legal incapacitation declaration associated with the asset owner 214, among others. The trigger event may also include a detection of an inactivity to access a digital asset 204 hosted by a productivity service 203 during a period of time by the asset owner 214. The period of time may be defined by the asset owner 214 or an asset manager 210.

The asset owner 214 may create an initial workflow that includes a selection of digital assets such as the digital asset 204, trigger events and actions to dispose of the digital asset 204 in case of a detected trigger event. The asset owner 214 may create the initial workflow through a client UI of the management service 211 displayed on a client device 213. Alternatively, the asset manager 210 may create the initial workflow through a client UI of the management service 211 displayed on a client device 202. The asset manager 210 may include the asset owner 214, a legal representative of the asset owner 214, an authorized family member of the asset owner 214, an authorized relation of the asset owner 214, an authorized colleague of the asset owner 214, and an authorized supervisor of the asset owner 214, among others.

The content 208 hosted at an external resource (such as a content provider 207) and the digital asset 204 hosted at an external resource (such as a productivity service 203) may be monitored by the management service 211. The management service 211 may monitor the content 208 and the digital asset 204 to detect a trigger event of an incapacitation of the asset owner 214. The content may include information associated with the asset owner 214 such as news associated the asset owner 214. The digital asset 204 may also include information associated with the asset owner 214. The information may describe an incapacitation of the asset owner 214, which may be identified as the trigger event by the management service 211.

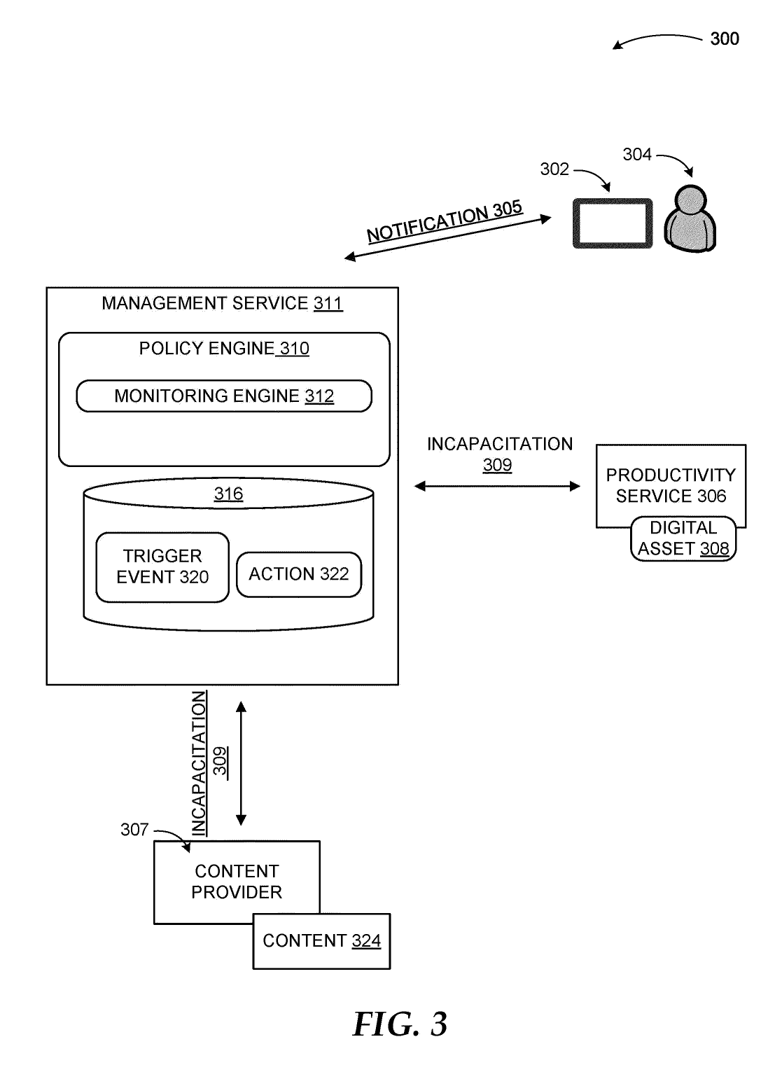

FIG. 3 illustrates a component diagram of a management service that provides trigger events and confirmation in digital asset management, according to embodiments.

In a diagram 300, a management service 311 may manage trigger events, digital assets, and actions of a workflow to dispose of the digital assets. An example of components of a workflow may include an action 322 selected by an asset manager 304 to dispose of a digital asset 308 (hosted by a productivity service 306), and a trigger event 320 identified in a content 324 (hosted by a content provider 307) associated with an asset owner.

A monitoring engine 312 of the management service may monitor the digital asset 308 and the content 324. The monitoring engine 312 may establish a connection with the productivity service 306 and the content provider 307. The monitoring engine 312 may query the digital asset 308 or the content 324 for information associated with an incapacitation 309 of the asset owner. The information that describes the incapacitation 309 of the asset owner may be identified as the trigger event 320.

The monitoring engine 312 may be a stand-alone component of the management service 311. Alternatively, the monitoring engine 312 may be a component of a policy engine 310. The policy engine 310 may be an analysis component of the management service 311. The policy engine may analyze information within the content 324 (or the digital asset 308) to detect an incapacitation 309 associated with the asset owner. The information may be processed to detect the trigger event 320. The information may include news associated with the asset owner. The news may include a death of the asset owner, a disablement of the asset owner, a hospitalization of the asset owner, an expatriation of the asset owner, a permanent relocation of the asset owner, an imprisonment of the asset owner, and a legal incapacitation declaration associated with the asset owner, among others.

Alternatively, the asset manager may transmit an input through a client UI of the management service 311. The input may identify the trigger event 320 that confirms the incapacitation 309 of the asset owner. In another example scenario, the incapacitation 309 of the asset owner may be inferred from multiple sources. A presence information associated with the asset owner retrieved from the content 324 or the digital asset 308 may be analyzed to deduce the trigger event 320. The policy engine 310 may process the asset owner's location and the incapacitation event's location identified within the presence information. A matching between the asset owner's location and the incapacitation event's location at a time of the incapacitation event may be identified as the trigger event 320.

In another example scenario, the policy engine 310 may process the content 324 to identify a legal declaration associated with the asset owner. The legal declaration may include a death certificate of the asset owner, an estate sale document associated with the asset owner, and a legal incapacitation declaration of the asset owner, among others. The policy engine 310 may identify the legal declaration as the trigger event 320.

An inactivity to access the digital asset 308 during a period of time by the asset owner may also be processed to detect the trigger event 320. The period of time may be configured by the asset owner of the asset manager 304.

A notification 305 may be transmitted to the asset manager 304 through a client UI displayed on the client device 302. The notification may prompt the asset manager to validate the incapacitation 309 of the asset owner. The action 322 may be confirmed with the asset manager 304. The action 322 may include closure of the digital asset 308 of the asset owner, a distribution of the digital asset 308 to an authorized relation, a removal of the digital asset 308, and a preservation of the digital asset 308, among others. The digital asset 308 may include data of the asset owner, an account of the asset owner, among others. The action 322 may also include a transmission of an announcement of the incapacitation 309 of the asset owner to interested parties as identified by the asset owner or the asset manager 304.

A text based message, an email, a voice recording, an interactive audio stream, or an interactive video conference call may be transmitted as the notification 305 to the asset manager 304. In response to a failure to receive the confirmation of the incapacitation 309 from the asset manager 304, the policy engine 310 may pause for a period of time. The period of time may be defined by the asset manager 304 or the asset owner to allow the asset manager 304 to provide the confirmation of the incapacitation 309. After the period of time, the policy engine 310 may execute the action 322 to dispose of the digital asset 308.

Alternatively, a next authorized relation associated with the asset owner may be identified from a list of authorized relations (the list may include the asset manager 304). The notification 305 may be transmitted to the next authorized relation to prompt the next authorized relation to validate the incapacitation 309 of the asset owner. The notification 305 may be transmitted to subsequent next authorized relation in the list in case of continued failure to receive a confirmation from one of the next authorized relations.

The trigger event 320 and the action 322 may be stored in a data store 316. Suggested trigger events, suggested actions, and digital assets of the asset owner may be transmitted to the asset manager or the asset owner (prior to the incapacitation 309) to allow the asset manager or the asset owner to customize the trigger event 320, the action 322, or a selection of the digital asset 308 for disposition in case of the trigger event 320.

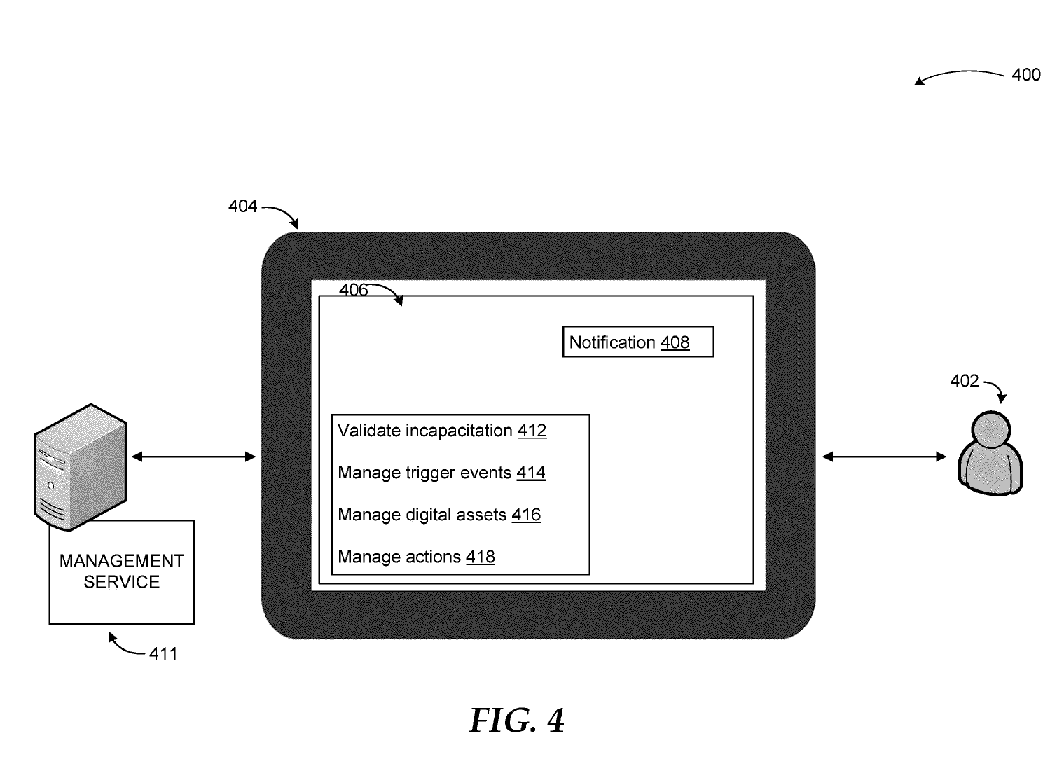

FIG. 4 illustrates an example of a user interface to provide trigger events and confirmation in digital asset management, according to embodiments.

In a diagram 400, a management service 411 may provide a client UI 406 on a computing device 404 to allow an asset manager 402 to review and validate a notification 408 of a trigger event of an incapacitation of the asset owner. The client UI 406 may also display controls to allow the asset manager 402 to customize suggested trigger events, the selected digital assets, the actions to dispose of the selected digital assets.

The client UI 406 may display a notification 408 that may include display information about a detected trigger event. The information may describe an incapacitation of the asset owner, a source of the information such as a content associated with the asset owner, or the digital content, among others. The information may also identify a type, a time, and a location of the incapacitation, among other information associated with the incapacitation.

The notification 408 request that the asset manager 402 validate the trigger event. The asset manager 402 may be allowed to activate a “validate incapacitation” control 412 to prompt the management service 411 to execute actions to dispose of the digital asset of the asset owner.

The client UI 406 may also display controls to allow the asset manager 402 to customize trigger events in case of a false positive identification of an incapacitation of the asset owner, among other reasons. A “manage trigger events” control 414 (upon activation) may provide additional controls to select and modify suggested trigger events that identify an incapacitation of the asset owner. An example may include a list of suggested trigger events describing the incapacitation of the asset owner. The list may include a death of the asset owner, a disablement of the asset owner, an expatriation of the asset owner, a permanent relocation of the asset owner, an imprisonment of the asset owner, and a legal incapacitation declaration associated with the asset owner, among others. The asset manager 402 may be provided with controls to select and modify the trigger events from the list.

A “manage digital assets” control 416 may provide the asset manager 402 with additional controls to modify a list of digital assets associated with the asset owner. The asset manager 402 may be provided with the additional controls to select a subset of the digital assets to monitor for disposition in case of a trigger event.

A “manage actions” control 418 (upon activation) may provide additional controls to select and modify suggested actions that include operations to dispose of the digital assets of the asset owner. An example may include a list of suggested actions such as a delete action, a forward action, among others. The asset manager 402 may be provided with controls to select and modify the suggested actions from the list.

According to embodiments described herein, the technical advantage of trigger events and confirmation in digital asset management may include improved usability of digital assets with optimized actions generated to manage digital assets of an asset owner after an incapacitation event. A workflow of digital asset management actions to dispose of the digital assets may address a need that arises from extensive digital personalities generated by asset owners in an extensive digital world. The workflow of digital asset management actions may streamline disposition of the digital assets following the incapacitation event compared to cumbersome legacy manual asset review solutions.

Embodiments address a need that arises from very large scale of operations created by networked computing and cloud based services that cannot be managed by humans. The actions/operations described herein are not a mere use of a computer, but address results of a system that is a direct consequence of software used as a service such as digital asset management services offered in conjunction with digital asset owner incapacitation.

The example scenarios and schemas in FIG. 1 through 4 are shown with specific components, data types, and configurations. Embodiments are not limited to systems according to these example configurations. Trigger events and confirmation in digital asset management may be implemented in configurations employing fewer or additional components in applications and user interfaces. Furthermore, the example schema and components shown in FIG. 1 through 4 and their subcomponents may be implemented in a similar manner with other values using the principles described herein.

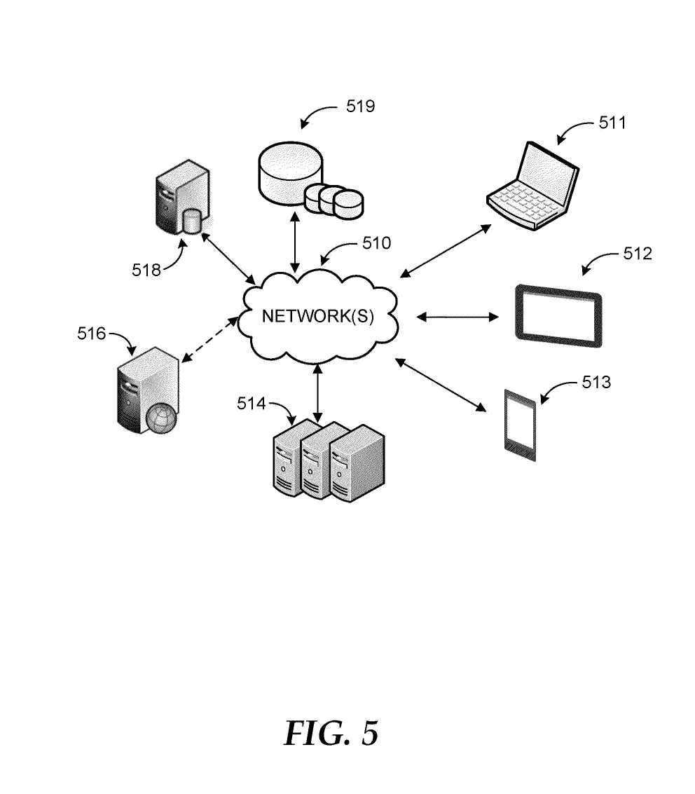

FIG. 5 is an example networked environment, where embodiments may be implemented. A management service configured to provide trigger events and confirmation in digital asset management may be implemented via software executed over one or more servers 514 such as a hosted service. The platform may communicate with client applications on individual computing devices such as a smart phone 513, a mobile computer 512, or desktop computer 511 (‘client devices’) through network(s) 510.

Client applications executed on any of the client devices 511-513 may facilitate communications via application(s) executed by servers 514, or on individual server 516. A management service may monitor digital assets of an asset owner and content associated with the asset owner hosted at external resources. A trigger event may be detected within the content or the digital assets. A notification may be transmitted to an asset manager to prompt the asset manager to validate an incapacitation of the asset owner associated with the trigger event. In response to a confirmation of the incapacitation, the actions may be executed to dispose of the digital assets. The management service may store data associated with digital asset in data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to provide trigger events and confirmation in digital asset management. Furthermore, the networked environments discussed in FIG. 5 are for illustration purposes only. Embodiments are not limited to the example applications, modules, or processes.

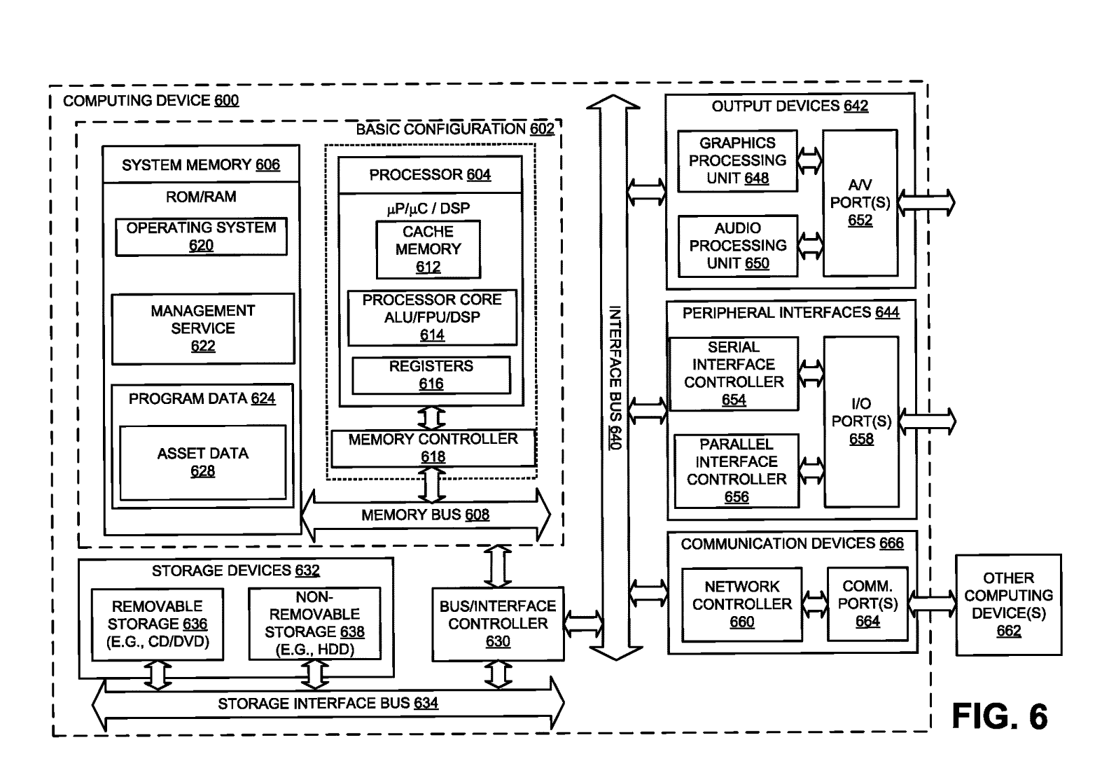

FIG. 6 illustrates a general purpose computing device, which may be configured to provide trigger events and confirmation in digital asset management, arranged in accordance with at least some embodiments described herein.

For example, the computing device 600 may be used to provide trigger events and confirmation in digital asset management. In an example of a basic configuration 602, the computing device 600 may include one or more processors 604 and a system memory 606. A memory bus 608 may be used for communication between the processor 604 and the system memory 606. The basic configuration 602 may be illustrated in FIG. 6 by those components within the inner dashed line.

Depending on the desired configuration, the processor 604 may be of any type, including, but not limited to, a microprocessor (μP), a microcontroller (μC), a digital signal processor (DSP), or any combination thereof. The processor 604 may include one more levels of caching, such as a level cache memory 612, a processor core 614, and registers 616. The processor core 614 may include an arithmetic logic unit (ALU), a floating point unit (FPU), a digital signal processing core (DSP Core), or any combination thereof. A memory controller 618 may also be used with the processor 604, or in some implementations, the memory controller 618 may be an internal part of the processor 604.

Depending on the desired configuration, the system memory 606 may be of any type including but not limited to volatile memory (such as RAM), non-volatile memory (such as ROM, flash memory, etc.), or any combination thereof. The system memory 606 may include an operating system 620, a management service 622, and a program data 624. The management service 622 may monitor digital assets of an asset owner and content associated with the asset owner hosted at external resources. A trigger event may be detected within the content or the digital assets. A notification may be transmitted to an asset manager to prompt the asset manager to validate an incapacitation of the asset owner associated with the trigger event. In response to a confirmation of the incapacitation, the actions may be executed to dispose of the digital assets. Components of the management service 622 (such as a client user interface) may also be displayed on a display device. An example of the display device may include another computing device with a display component. The display device may include a touch based device that detects gestures such as a touch action. The display device may also provide feedback in response to detected gestures (or any other form of input) by transforming a client user interface of the management service 622, displayed by the touch based device. The program data 624 may also include, among other data, asset data 628, or the like, as described herein. The asset data 628 may include a digital asset, a suggested action, a suggested trigger event, among others.

The computing device 600 may have additional features or functionality, and additional interfaces to facilitate communications between the basic configuration 602 and any desired devices and interfaces. For example, a bus/interface controller 630 may be used to facilitate communications between the basic configuration 602 and one or more data storage devices 632 via a storage interface bus 634. The data storage devices 632 may be one or more removable storage devices 636, one or more non-removable storage devices 638, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 606, the removable storage devices 636, and the non-removable storage devices 638 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 600. Any such computer storage media may be part of the computing device 600.

The computing device 600 may also include an interface bus 640 for facilitating communication from various interface devices (for example, one or more output devices 642, one or more peripheral interfaces 644, and one or more communication devices 666) to the basic configuration 602 via the bus/interface controller 630. Some of the example output devices 642 may include a graphics processing unit 648 and an audio processing unit 650, which may be configured to communicate to various external devices, such as a display or speakers via one or more A/V ports 652. One or more example peripheral interfaces 644 may include a serial interface controller 654 or a parallel interface controller 656, which may be configured to communicate with external devices, such as input devices (for example, keyboard, mouse, pen, voice input device, touch input device, etc.) or other peripheral devices (for example, printer, scanner, etc.) via one or more I/O ports 658. An example communication device 666 may include a network controller 660, which may be arranged to facilitate communications with one or more other computing devices 662 over a network communication link via one or more communication ports 664. The one or more other computing devices 662 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 600 may be implemented as a part of a general purpose or specialized server, mainframe, or similar computer, which includes any of the above functions. The computing device 600 may also be implemented as a personal computer including both laptop computer and non-laptop computer configurations.

Example embodiments may also include methods to provide trigger events and confirmation in digital asset management. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

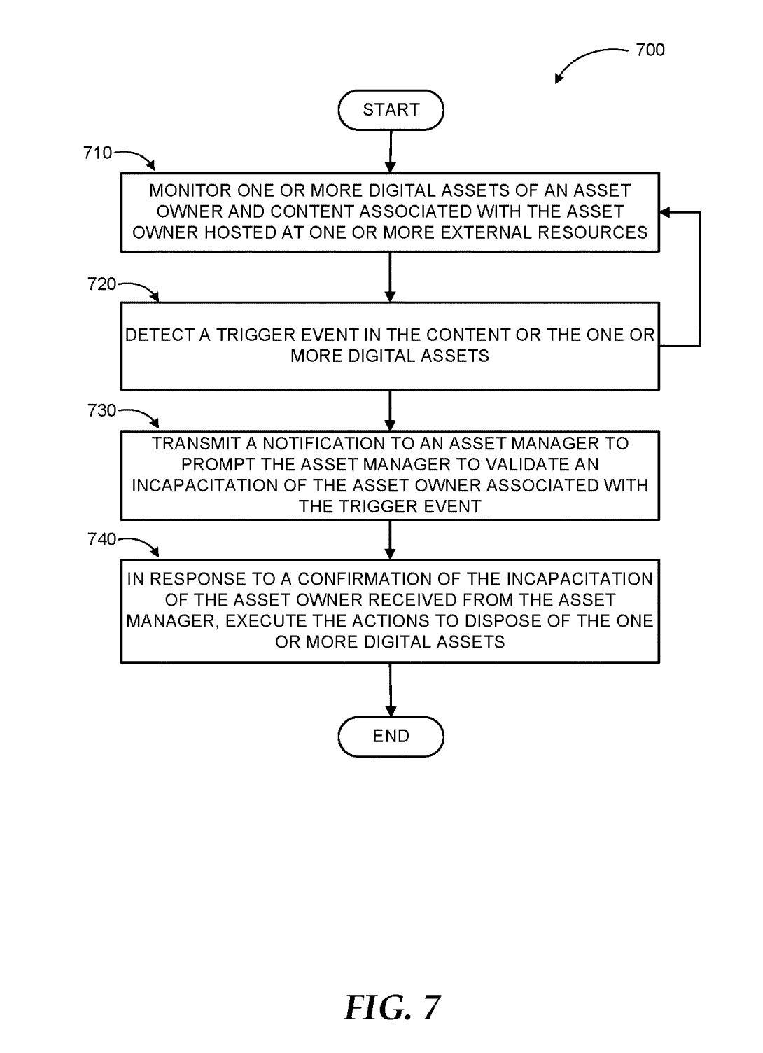

FIG. 7 illustrates a logic flow diagram for a process to provide trigger events and confirmation in digital asset management, according to embodiments. Process 700 may be implemented on a management service.

Process 700 begins with operation 710, where digital assets of an asset owner and a content associated with the asset owner hosted at external resources may be monitored by a management service. At operation 720, a trigger event may be detected in the content or the digital assets. The trigger event may include an information of an incapacitation of the asset owner. A notification may be transmitted to an asset manager to prompt the asset manager to validate the incapacitation of the asset owner associated with the trigger event at operation 730. The notification may identify a time, a location, and a type, among other attributes of the incapacitation. At operation 740, actions to dispose of the digital assets may be executed in response to a confirmation of the incapacitation of the asset owner received from the asset manager.

Some or all of the operations of the process 700 may be reprocessed with feedback operations. In an example scenario, the trigger event identified in the operation 720 may be used as input to monitor related digital assets in the operation 710. The related assets may include the trigger event in the operation 710. Other feedback loops may be used with other operations of the process 700 to customize operations of the process 700, among other things.

The operations included in process 700 are for illustration purposes. A management service according to embodiments may be implemented by similar processes with fewer or additional steps, as well as in different order of operations using the principles described herein.

According to some examples, a computing device to provide trigger events and confirmation in digital asset management may be described. The computing device may include a memory configured to store instructions associated with a management service and one or more processors coupled to the memory. The one or more processors may execute the management service in conjunction with instructions stored in the memory. The management service may include a monitoring engine configured to monitor one or more digital assets of an asset owner and content associated with the asset owner hosted at one or more external resources. The computing device may further include a policy engine configured to detect a trigger event associated with the asset owner or the content, transmit a notification to an asset manager to prompt the asset manager to confirm an incapacitation of the asset owner associated with the trigger event, and in response to a confirmation of the incapacitation of the asset owner received from the asset manager, execute one or more of the actions to dispose of the one or more digital assets.

According to other examples, the asset manager may include one or more of the asset owner, a legal representative of the asset owner, an authorized family member of the asset owner, an authorized relation of the asset owner, an authorized colleague of the asset owner, and an authorized supervisor of the asset owner. The policy engine may be further configured to receive an input from the asset manager and identify the input as the trigger event that confirms the incapacitation of the asset owner. The policy engine may be further configured to analyze one or more of the content and the one or more digital assets to identify an information associated with the asset owner and process the information to detect the trigger event within the information. The information may include the information includes one or more of a news associated with the asset owner, the news including one or more of a death of the asset owner, a disablement of the asset owner, a hospitalization of the asset owner, an expatriation of the asset owner, a permanent relocation of the asset owner, an imprisonment of the asset owner, a legal incapacitation declaration associated with the asset owner as the trigger event.

According to further examples, the policy engine may be further configured to analyze presence information associated with the asset owner within one or more of the content and the one or more digital assets to deduce the trigger event, process the presence information that includes a first location of the asset owner and a second location of an incapacitation event, and identify a matching of a first location of the asset owner to the second location of the incapacitation event at a time of the incapacitation event as the trigger event. The policy engine may be further configured to process the content to identify a legal declaration associated with the asset owner, where the legal declaration includes one or more of a death certificate of the asset owner, an estate sale document associated with the asset owner, and a legal incapacitation declaration of the asset owner and identify the legal declaration as the trigger event.

According to other examples, the policy engine may be further configured to detect an inactivity of the asset owner to access the one or more digital assets during a period of time and identify the inactivity as the trigger event. The policy engine may be further configured to confirm the actions with the asset manager, where the actions include one or more of a closure of the one or more digital assets of the asset owner, a distribution of the one or more digital assets to an authorized relation, a removal of the one or more digital assets, and a preservation of the one or more digital assets and, where the one or more digital assets include one or more of data of the asset owner and one or more accounts of the asset owner. The policy engine may be further configured to confirm the actions with the asset manager, where the actions include a transmission of an announcement of the incapacitation of the asset owner to interested parties as identified by one or more of the asset owner and the asset manager.

According to some examples, a method executed on a computing device to provide trigger events and confirmation in digital asset management may be provided. The method may include monitoring one or more digital assets of an asset owner and content associated with the asset owner hosted at one or more external resources, detecting a trigger event in one or more of the content and the one or more digital assets, where the trigger event is identified as an information of an incapacitation of the asset owner, transmitting a notification to an asset manager to prompt the asset manager to confirm the incapacitation of the asset owner associated with the trigger event, and in response to a confirmation of the incapacitation from the asset manager, executing one or more of the actions to dispose of the digital assets.

According to other examples, the method may further include transmitting one or more of a text based message, an email, a voice recording, an interactive audio stream, and an interactive video conference call as the notification to the asset manager. The method may further include in response to a failure to receive the confirmation of the incapacitation from the asset manager, waiting for a period of time as defined by one or more of asset manager and the asset owner to allow the asset manager to provide the confirmation. The method may further include upon an expiration of the period of time, continuing with an execution of the one or more of the actions to dispose of the one or more digital assets. The method may further include identifying a next authorized relation associated with the asset owner from a list of authorized relations that includes the asset manager and transmitting the notification to the next authorized relation to prompt the next authorized relation to confirm the incapacitation of the asset owner associated with the trigger event. The method may further include transmitting suggested trigger events, suggested actions, and the one or more digital assets to the asset manager to allow the asset manager to customize the trigger event and the actions for a selection from the one or more digital assets.

According to some examples a computer-readable memory device with instructions stored thereon to provide trigger events and confirmation in digital asset management may be described. The instructions may include actions that are similar to the method described above.

According to some examples, a means to provide trigger events and confirmation in digital asset management may be described. The means to provide trigger events and confirmation in digital asset management may include a means to monitor one or more digital assets of an asset owner and content associated with the asset owner hosted at one or more external resources, a means to detect a trigger event associated with the asset owner or the content, a means to transmit a notification to an asset manager to prompt the asset manager to confirm an incapacitation of the asset owner associated with the trigger event, and a means to execute one or more of the actions to dispose of the one or more digital assets in response to a confirmation of the incapacitation of the asset owner received from the asset manager.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to provide trigger events and confirmation in digital asset management, the computing device comprising:
a memory configured to store instructions associated with a management service;
one or more processors coupled to the memory, the one or more processors executing the management service in conjunction with the instructions stored in the memory, wherein the management service includes:
a monitoring engine configured to:
monitor one or more digital assets of an asset owner and content associated with the asset owner hosted at one or more external resources;
a policy engine configured to:
detect a trigger event associated with the asset owner in the content;
transmit a notification to an asset manager to prompt the asset manager to confirm an incapacitation of the asset owner associated with the trigger event; and
in response to a confirmation of the incapacitation of the asset owner received from the asset manager, execute one or more of the actions to dispose of the one or more digital assets.

2. The computing device of claim 1, wherein the asset manager includes one or more of the asset owner, a legal representative of the asset owner, an authorized family member of the asset owner, an authorized relation of the asset owner, an authorized colleague of the asset owner, and an authorized supervisor of the asset owner.

3. The computing device of claim 1, wherein the policy engine is further configured to:
receive an input from the asset manager; and
identify the input as the trigger event that confirms the incapacitation of the asset owner.

4. The computing device of claim 1, wherein the policy engine is further configured to:
analyze one or more of the content and the one or more digital assets to identify an information associated with the asset owner; and
process the information to detect the trigger event within the information.

5. The computing device of claim 4, wherein the information includes one or more of a news associated with the asset owner, the news including one or more of a death of the asset owner, a disablement of the asset owner, a hospitalization of the asset owner, an expatriation of the asset owner, a permanent relocation of the asset owner, an imprisonment of the asset owner, a legal incapacitation declaration associated with the asset owner as the trigger event.

6. The computing device of claim 1, wherein the policy engine is further configured to:
analyze presence information associated with the asset owner within one or more of the content and the one or more digital assets to deduce the trigger event.

7. The computing device of claim 6, wherein the policy engine is further configured to:
process the presence information that includes a first location of the asset owner and a second location of an incapacitation event; and
identify a matching of a first location of the asset owner to the second location of the incapacitation event at a time of the incapacitation event as the trigger event.

8. The computing device of claim 1, wherein the policy engine is further configured to:
process the content to identify a legal declaration associated with the asset owner, wherein the legal declaration includes one or more of a death certificate of the asset owner, an estate sale document associated with the asset owner, and a legal incapacitation declaration of the asset owner; and
identify the legal declaration as the trigger event.

9. The computing device of claim 1, wherein the policy engine is further configured to:
detect an inactivity of the asset owner to access the one or more digital assets during a period of time; and
identify the inactivity as the trigger event.

10. The computing device of claim 1, wherein the policy engine is further configured to:
confirm the actions with the asset manager, wherein the actions include one or more of a closure of the one or more digital assets of the asset owner, a distribution of the one or more digital assets to an authorized relation, a removal of the one or more digital assets, and a preservation of the one or more digital assets and, wherein the one or more digital assets include one or more of data of the asset owner and one or more accounts of the asset owner.

11. The computing device of claim 1, wherein the policy engine is further configured to:
confirm the actions with the asset manager, wherein the actions include a transmission of an announcement of the incapacitation of the asset owner to interested parties as identified by one or more of the asset owner and the asset manager.

12. A method executed on a computing device to provide trigger events and confirmation in digital asset management, the method comprising:
monitoring one or more digital assets of an asset owner and content associated with the asset owner hosted at one or more external resources;
detecting a trigger event in one or more of the content and the one or more digital assets, wherein the trigger event is identified as an information of an incapacitation of the asset owner;
transmitting a notification to an asset manager to prompt the asset manager to confirm the incapacitation of the asset owner associated with the trigger event; and
in response to a confirmation of the incapacitation from the asset manager, executing one or more of the actions to dispose of the digital assets.

13. The method of claim 12, further comprising:
transmitting one or more of a text based message, an email, a voice recording, an interactive audio stream, and an interactive video conference call as the notification to the asset manager.

14. The method of claim 12, further comprising:
in response to a failure to receive the confirmation of the incapacitation from the asset manager, waiting for a period of time as defined by one or more of asset manager and the asset owner to allow the asset manager to provide the confirmation.

15. The method of claim 14, further comprising:
upon an expiration of the period of time, continuing with an execution of the one or more of the actions to dispose of the one or more digital assets.

16. The method of claim 14, further comprising:
identifying a next authorized relation associated with the asset owner from a list of authorized relations that includes the asset manager; and
transmitting the notification to the next authorized relation to prompt the next authorized relation to confirm the incapacitation of the asset owner associated with the trigger event.

17. The method of claim 12, further comprising:
transmitting suggested trigger events, suggested actions, and the one or more digital assets to the asset manager to allow the asset manager to customize the trigger event and the actions for a selection from the one or more digital assets.

18. A computer-readable memory device with instructions stored thereon to provide trigger events and confirmation in digital asset management, the instructions comprising:
monitoring one or more digital assets of an asset owner and content associated with the asset owner hosted at one or more external resources;
detecting a trigger event in one or more of the content and the one or more digital assets, wherein the trigger event is identified as an information of an incapacitation of the asset owner within the one or more of the content and the one or more digital assets;
transmitting a notification to an asset manager to prompt the asset manager to confirm the incapacitation of the asset owner associated with the trigger event; and
in response to a confirmation of the incapacitation from the asset manager, executing one or more of the actions to dispose of the one or more digital assets.

19. The computer-readable memory device of claim 18, wherein the instructions further comprise:
analyzing presence information associated with the asset owner from one or more of the content and the one or more digital assets to deduce the trigger event;
processing the presence information that includes a first location of the asset owner and a second location of an incapacitation event; and
identifying a matching of a first location of the asset owner to the second location of the incapacitation event at a time of the incapacitation event as the trigger event.

20. The computer-readable memory device of claim 18, wherein the instructions further comprise:
in response to a failure to receive the confirmation of the incapacitation from the asset manager, waiting for a period of time as defined by one or more of asset manager and the asset owner to allow the asset manager to provide the confirmation;
identifying a next authorized relation associated with the asset owner from a list of authorized relations that includes the asset manager; and
transmitting the notification to the next authorized relation to confirm the incapacitation of the asset owner associated with the trigger event.
